(19) United States
(12) Patent Application Publication
(10) Pub. No.: US 2019/0196805 A1
(43) Pub. Date: Jun. 27, 2019

(54) CONTROLLED ROLLOUT OF UPDATES FOR APPLICATIONS INSTALLED ON CLIENT DEVICES

(71) Applicant: Apple Inc., Cupertino, CA (US)

(72) Inventors: Jonathan M. LEE, Sunnyvale, CA (US); Hiren R. KOTADIA, Sunnyvale, CA (US); Mufaddal Y. KHUMRI, San Jose, CA (US); Michael L. WIESE, Cupertino, CA (US)

(21) Appl. No.: 15/957,810

(22) Filed: Apr. 19, 2018

Related U.S. Application Data
(60) Provisional application No. 62/609,250, filed on Dec. 21, 2017.

(51) Int. Cl. G06F 8/65; H04L 12/24; G06F 8/71; H04L 29/06

(52) U.S. Cl. CPC G06F 8/65; H04L 63/104; G06F 8/71; H04L 41/082

(57) ABSTRACT

This application relates to controlling a rollout for an update to an application installed on client devices. A digital distribution platform can include at least one server connected to a network and configured to enable client devices to access resources, stored on network devices, so that applications or updates to applications can be installed on the client devices. A server can implement a service that receives a request to identify whether the update is available via a digital distribution platform and determine whether a client device is authorized to install the update. The service can be configured to sort the client device into a first subset of client devices or a second subset of client devices based on a user identifier, a version identifier, and (optionally) an application identifier. In this manner, the service can implement a gradual rollout of an update over a period of time.

### CROSS-REFERENCE TO RELATED APPLICATIONS

The present application claims the benefit of U.S. Provisional Application No. 62/609,250, entitled “CONTROLLED ROLLOUT OF UPDATES FOR APPLICATIONS INSTALLED ON CLIENT DEVICES,” filed Dec. 21, 2017, the content of which is incorporated herein by reference in its entirety for all purposes.

### FIELD

The described embodiments relate generally to software updates. More particularly, the present embodiments relate to a controlled technique for rolling out application updates to client devices.

### BACKGROUND

Software developers can utilize digital distribution platforms that enable client devices to install digital copies of applications developed by the software developers. An example of a digital distribution platform includes Apple's® App Store® for devices running the iOS operating system. In turn, for a given client device that installs a particular application produced by a software developer, the software developer can provide updates for the application via the digital distribution platform. In some cases, the client device can be configured to download and install the updates automatically without user interaction. Alternatively, the client device can be configured to indicate when updates are available and prompt a user to manually install the update.

Notably, conventional digital distribution platforms do not provide software developers with fine-granularity control with respect to how their software applications are rolled out to client devices—which, in some cases, can be numbered in the millions. Typically, a conventional digital distribution platform implements a service that enables a given software developer to upload an update to a particular application to servers associated with the digital distribution platform. In turn, the digital distribution platform enables all client devices that previously-installed the application to install the update at their discretion. Importantly, although software developers may implement a form of quality control that involves testing the updated application during its development, the updated application nonetheless tends to include bugs that surface during operation. Consequently, the software developer is faced with pressure to, in a very short time, release an update that addresses the bugs. This rushed environment typically leads to unaddressed and/or additional bugs, thus exacerbating the problem.

### SUMMARY

In view of the foregoing, what is desired is an improved technique for performing a rollout of software updates within a digital distribution platform. In this regard, the embodiments described herein set forth techniques for providing a gradual rollout option that can be selected when a software developer causes an update to be made available to client devices via the digital distribution platform.

In some embodiments, at least one server implements a process that includes steps for receiving a request to identify whether an update for an application is available via a digital distribution platform, and determining whether a client device is authorized to install the update. The process can include sorting the client device into a first subset of client devices or a second subset of client devices based on (i) a user identifier corresponding to a user account associated with the client device, and (ii) a version identifier corresponding to the update. In particular, client devices sorted into the first subset of client devices are authorized to install the update, and client devices sorted into the second subset of client devices are not authorized to install the update. In some embodiments, the sorting can be performed in accordance with a hash value that is generated using a hash function that is applied against the user identifier and the version identifier provided by the client device and/or retrieved from a server device. In turn, the hash value can be compared to a threshold value to effectively sort the client device into the first subset of devices or the second subset of devices. In various embodiments, the threshold value can be adjusted dynamically during the rollout based on a function. In particular, the function can be dependent on one or more variables such as an elapsed amount of time between a release date for the update and a current date. In various embodiments, the process can include transmitting a response to the client device when the client device is authorized to install the update.

In various embodiments, the digital distribution platform can include at least one server computing device configured to implement one or more services. Exemplary services implemented by the at least one server computing device can include, but are not limited to, a content submission service, an indexing service, a distributed search service, and an update discovery service. The digital distribution platform can also include a digital store that enables purchasing applications that can be installed on client devices. In some embodiments, the digital distribution platform can include one or more content distribution networks, where each content distribution network includes a gateway server and one or more storage servers for storing packages of resources for different versions of one or more applications.

Other aspects and advantages of the application will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of various computing devices that can be configured to implement different aspects of the various techniques described herein, in accordance with some embodiments.

FIG. 2 illustrates a conceptual diagram of an application development timeline, in accordance with some embodiments.

FIGS. 3A-3D illustrate conceptual diagrams of various services, executing on a server computing device, that implement various aspects of a digital distribution platform, in accordance with some embodiments.

FIG. 4 illustrates an exemplary function for selecting a threshold value associated with a controlled rollout of an update for an application, in accordance with some embodiments.

FIG. 5 illustrates a flowchart of an exemplary method to control a rollout for an update to an application installed on client devices, in accordance with some embodiments.

FIG. 6 illustrates a flowchart of an exemplary method for determining whether a client device is authorized to access an update to an application, in accordance with some embodiments.

FIG. 7 illustrates a detailed view of an exemplary computing device that can be used to implement the various apparatus and/or methods described herein, in accordance with some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Digital distribution platforms enable software developers to rollout software to a large number of network-connected client devices in an automated manner. Various applications installed on client devices can also be updated automatically. Improvements to the digital distribution platforms that enable rollouts of updates to applications installed on client devices are discussed in detail herein. In one aspect of the various embodiments, a technique for implementing a gradual rollout option is disclosed, and can involve slowly increasing, over a period of time, the number of client devices that are authorized to install an update. According to some embodiments, the client devices can be sorted using a hash function and a threshold value that divides the client devices into two subsets based on a comparison of the hash value assigned to a particular client device and the threshold value. Additionally, the threshold value can be controlled (e.g., increased) during the rollout (automatically, or manually) to effectively adjust the number of client devices that are authorized to install the update during the rollout.

Effectively determining whether a client device is authorized to install an update during the rollout is an important aspect of the various embodiments. For example, a particular user can utilize a number of different client devices associated with a common user account. Notably, it can be important for a software developer to maintain a consistent user experience across different instances of an application installed on multiple client devices. In this regard, care should be taken to always authorize or not authorize all client devices associated with the common user account to install a particular update for a particular application. Similarly, care should also be taken to ensure that a particular client device is not consistently authorized to install an update to any application at a similar point during the rollout. Additionally, whether a client device is subject to become an early adopter of an update during a rollout should be varied across different updates and applications so that a given user is not consistently used as a beta tester early in the rollouts of multiple updates. Utilizing a user identifier, an application identifier, and a version identifier in a determination of whether a client device is authorized to install an update for an application can ensure consistency across multiple associated client devices for a given version of an application.

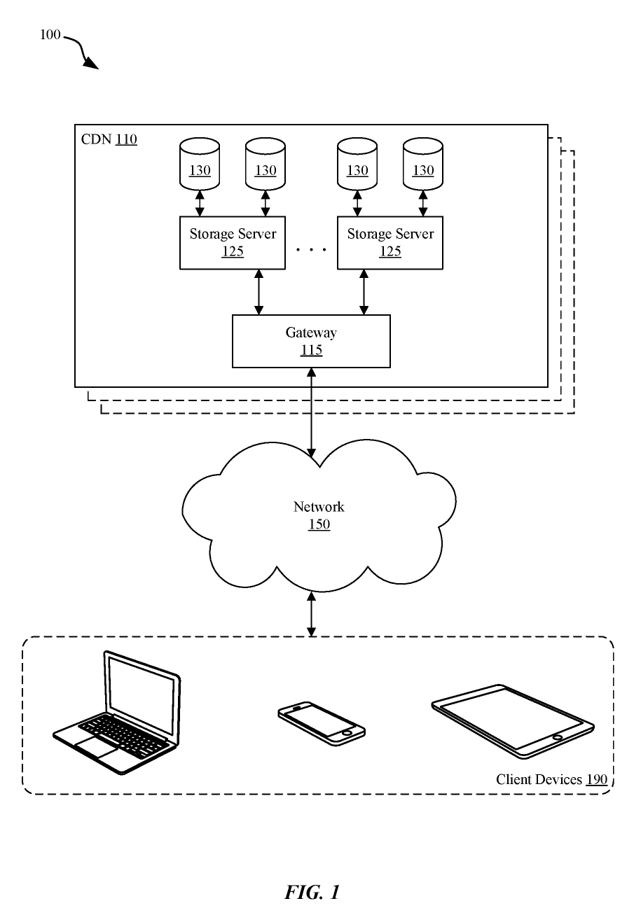

These and other embodiments are discussed below with reference to FIGS. 1-7; however, those skilled in the art will readily appreciate that the detailed description given herein with respect to these figures is for explanatory purposes only and should not be construed as limiting.

FIG. 1 illustrates a block diagram of various computing devices that can be configured to implement different aspects of the techniques described herein, in accordance with some embodiments. The computing devices shown in FIG. 1 can be configured to implement a digital distribution platform 100. The digital distribution platform 100 can include one or more content delivery networks (CDNs) 110. In some embodiments, a CDN 110 includes a gateway server 115, as well as one or more storage servers 125 that are coupled to storage resources 130 for storing binary executables for applications that are uploaded to the digital distribution platform 100 by software developers. The gateway server 115 includes a network interface that is connected to an external network 150. The external network 150 can be a local area network (LAN), a wireless local area network (WLAN), an ad hoc network, or a distributed network such as the Internet.

Client devices 190 can be connected to the network 150. The client devices 190 can include a network interface, such as an Ethernet interface (IEEE 802.3) or a Wi-Fi interface (IEEE 802.11), that enables the client device 190 to communicate with other devices connected to the network 150. In some embodiments, a client device 190 includes a client application configured to communicate with a gateway server 115 of a CDN 110 in order to access a binary executable for an application to install on the client device 190. In particular, the client application can enable the client device to locate a uniform resource locator (URL) for the binary executable and to download the binary executable using the URL. In various embodiments, the client application can be a web-based application that is viewed in a browser of the client device 190.

Client devices 190 can include, but are not limited to, wearables, hand-held consumer devices, mobile phones, tablet computers, laptop computers, desktop computers, gaming consoles, or any other electronic device capable of connecting to the network 150 and installing a binary executable for an application stored on the CDN 110. Each client device 190 can include a processor and memory storing instructions and data that can be accessed by the processor. In some embodiments, a client device 190 can include an operating system that, when executed by the processor, enables the client device 190 to run one or more applications installed on the client device 190.

In some embodiments, the gateway server 115 and the storage server(s) 125 can be implemented on a single node connected to the network 150. For example, a single workstation connected to the network 150 can include storage resources 130 implemented as a RAID drive array. The workstation can also include a network interface connected to the network 150. In addition, the workstation can include a processor executing instructions to implement a service that provides various functionalities of the CDN 110 to the client devices 190. For example, the service can enable a client device 190 to query the CDN 110 for available file resources stored on the storage resources 130, enable software developers to upload binary executables for applications to the CDN 110, and so forth. In various embodiments, the gateway server 115 and storage server(s) 125 can be implemented as virtual machines (VMs) on the same node connected to the network 150.

In some embodiments, the gateway server 115 and storage server(s) 125 can be implemented across multiple nodes within a data center. Under such a configuration, the gateway server 115 can be configured to provide an interface between a local network within the data center and the external network 150. Moreover, each node in the data center can be assigned a unique address within the local network, and the gateway server 115 can be configured to route traffic (e.g., data packets) between the external network 150 and the nodes within the data center. Additionally, each storage server 125 can be implemented on a different node that is assigned a unique address in the local network.

In some embodiments, each storage server 125 manages one or more storage resources 130 connected to the storage server 125. A storage resource 130 can refer to a physical storage resource such as a hard disk drive (HDD), a solid-state drive (SSD), a redundant array of inexpensive disks (RAID), an optical disc drive, a magnetic tape drive, or any other type of storage medium. Alternatively, a storage resource 130 can refer to a virtual storage resource such as a virtual block device that is a software abstraction of a physical storage resource. Virtual storage resources can be distributed over a plurality of physical storage resources. In various embodiments, each storage resource 130 can be included within the same node as a storage server 125, such as HDDs attached to an interface component of the storage server 125, or included within a different node of the data center. Alternatively, a storage resource 130 can refer to a cloud-based storage service implemented by at least one server and accessible to the storage server 125 via the network 150.

In some embodiments, a client device 190 can be configured to request an application to be installed on the client device 190. In turn, a binary executable associated with the application that is stored on one or more of the CDNs 110 is retrieved from a particular CDN 110 and loaded onto a memory of the client device 190. Additionally, various configuration parameters for the installed application can be stored in the memory of the client device 190. A processor of the client device 190 can then load the instructions included in the binary executable from the memory and execute the instructions to run the application.

As previously noted herein, a software developer that creates an application can discover bugs included in a current version of the application. The software developer can attempt to fix the discovered bugs by changing the source code for the application and compiling a new version of the application, thereby creating a new binary executable corresponding to the new version of the application. The software developer can then upload the new binary executable to the CDN 110. In turn, client devices 190 that request the application to be installed will install the new binary executable instead of the previous version of the application. Furthermore, client devices 190 that have installed the previous version of the application can delete the binary executable installed on the client device 190 and install the new binary executable to update the application to the new version of the application. In some embodiments, an application can refer to a package of resources that include a number of different binary executables plus zero or more data resources, such as configuration files, graphics files, and the like. In such embodiments, an update to the application can include only a subset of resources that will replace corresponding resources in the package of resources stored on the client device 190 for the current version of the application. Thus, the package of resources included in the update is reduced in size compared to a package of resources for a clean installation of the application in the first instance.

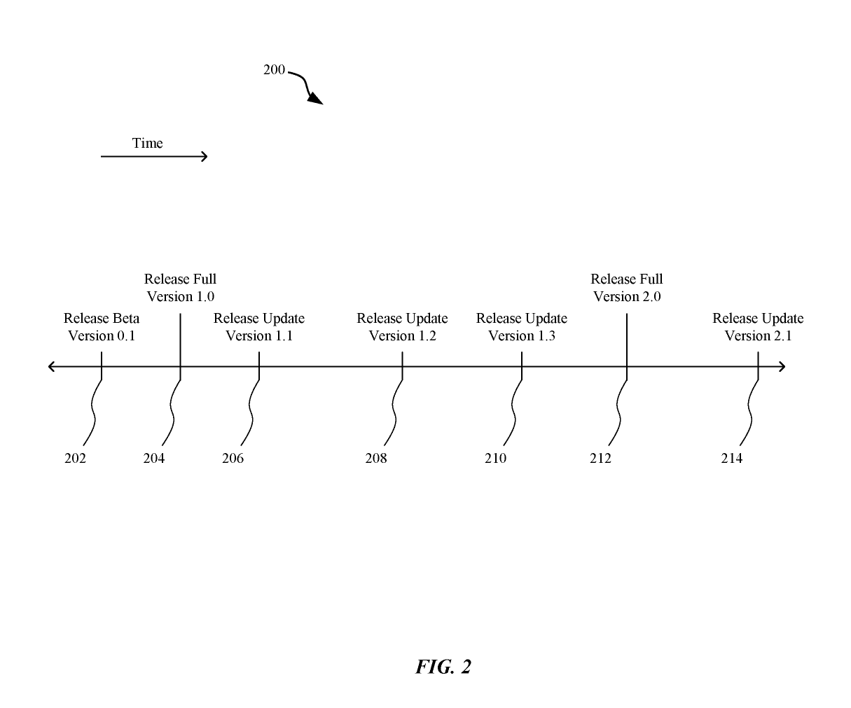

Accordingly, FIG. 1 provides a high-level overview of various computing devices that can be configured to operate in concert to implement the various techniques set forth herein. A more detailed breakdown of these techniques will now be described below in conjunction with FIGS. 2-7.

FIG. 2 illustrates a conceptual diagram of an application development timeline 200, in accordance with some embodiments. The development of an application typically involves designing a concept for the application, writing source code for the application, creating data resources for the application (e.g., texture maps, image files, audio files, configuration files, etc.), compiling the source code via a compiler to create one or more binary executables associated with a target platform (e.g., x86, PowerPC, ARM, etc.). In turn, the resources and the one or more binary executables are wrapped together to form a package that enables the application to be installed on a client device that implements the target platform. In another example, the compiler generates platform-independent bytecode for the application instead of the binary executables for a particular target platform. The bytecode can be interpreted by a just-in-time (JIT) compiler at runtime on a variety of different client devices to generate instructions for a particular platform implemented by the client device.

As shown in FIG. 2, the development progresses from the initial stages of conceptualization to a point where the software developer is ready to release an initial version of the application to be installed on a client device, which is commonly referred to as a beta version of the application. The software developer likely anticipates that additional bugs not caught during initial testing are likely to be discovered as the application executes in a normal operating environment on client devices rather than run in a test environment created by the software developer. In some deployments, a software developer will restrict the beta version to only be installed on a small number of client devices, which are commonly referred to as beta testers.

At time 202 within the application development timeline 200, the software developer creates a package of resources for the beta version of the application (e.g., ver. 0.1) and submits the package of resources for the beta version to a digital distribution platform, such as the digital distribution platform 100 of FIG. 1. The software developer initiates the rollout of the beta version of the application by authorizing a number of client devices to install the beta version of the application on the client device. As authorized client devices discover the availability of the beta version of the application, the client devices may retrieve the package of resources from the digital distribution platform and install the package of resources onto the client device. The client devices can be configured to provide feedback to the software developer regarding any bugs that are discovered during operation, and the software developer can modify the source code and or data resources to create a new version of the application. Furthermore, the software developer can pause or cancel a rollout if the discovered bugs are severe.

At time 204, the software developer is satisfied with all of the modifications made to the source code and/or data resources, and releases a full version of the application (e.g., ver. 1.0). In some embodiments, the package of resources of the full version of the application includes a complete set of binary executables and data resources for the application.

Over the course of the development timeline 200, additional versions of the application can be developed and released by the software developer. For example, as shown in FIG. 2, various updates for the application can be released by the software developer as different versions, e.g., update version 1.1 at time 206, update version 1.2 at time 208, and update version 1.3 at time 210. Again, each update for the application can include a package of resources to be installed on client devices on which previous versions of the application are installed. In various embodiments, the package of resources for an update for the application can include only a subset of the complete set of binary executables and/or data resources that have been modified compared to corresponding versions of the binary executables and/or data resources included in the package of resources for a major version of the application.

At some point during the development timeline 200, the software developer can decide to release a new full version of the application for a major update. The package of resources of the full version of the application typically includes a complete set of binary executables and data resources for the application, as modified from a previous version. At time 212, the software developer can release a new full version of the application (e.g., ver. 2.0), which includes a package of resources for a modified version of the application. When updating the application as installed on the client device to a new full version of the application, the client device can delete all binary executables and data resources associated with a previous version of the application and then install the complete set of binary executables and data resources for the new full version of the application.

Updates for the new full version of the application can be released as the development timeline 200 advances. For example, at time 214, a software developer can decide to release an update version 2.1 as well as additional updates at subsequent times in the development timeline 200.

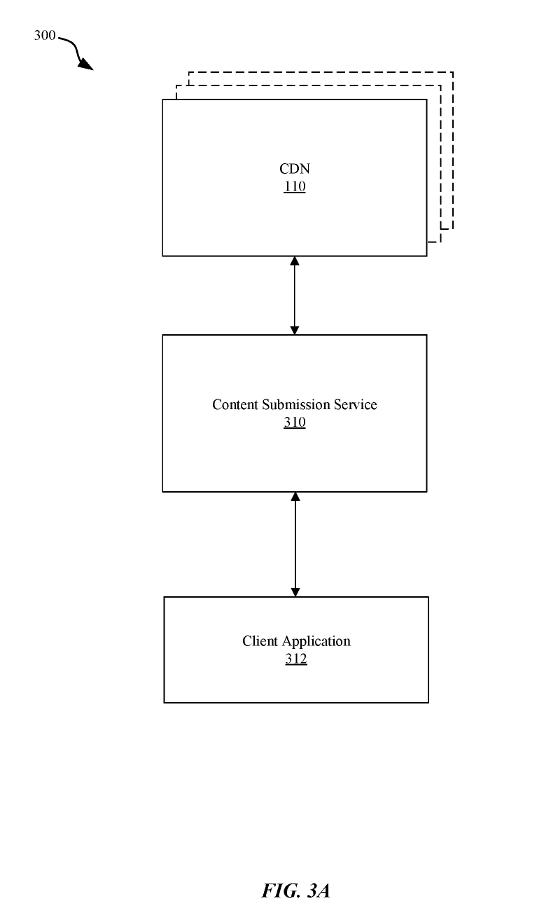

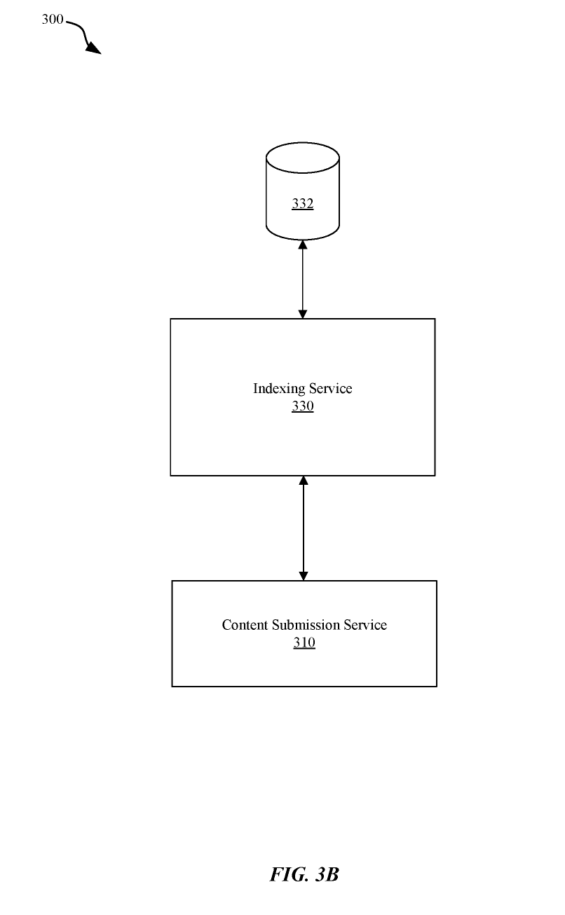

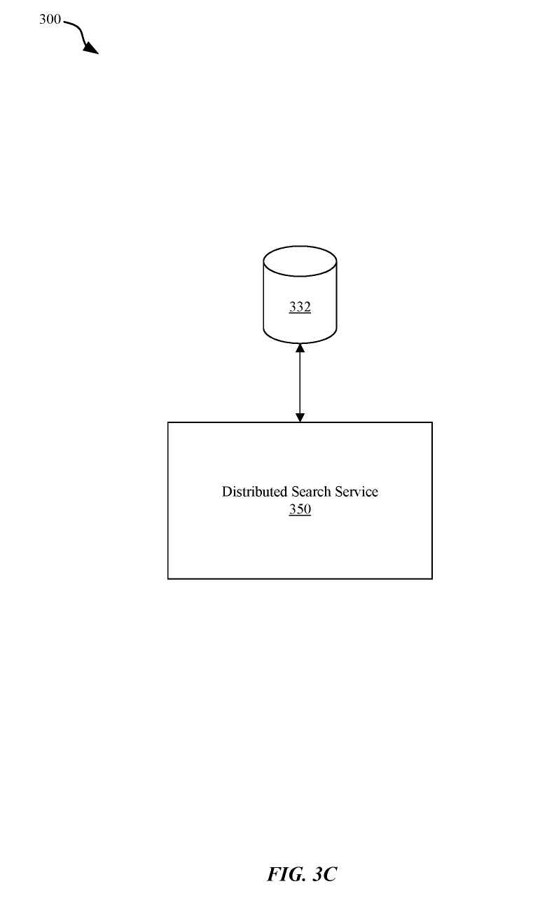

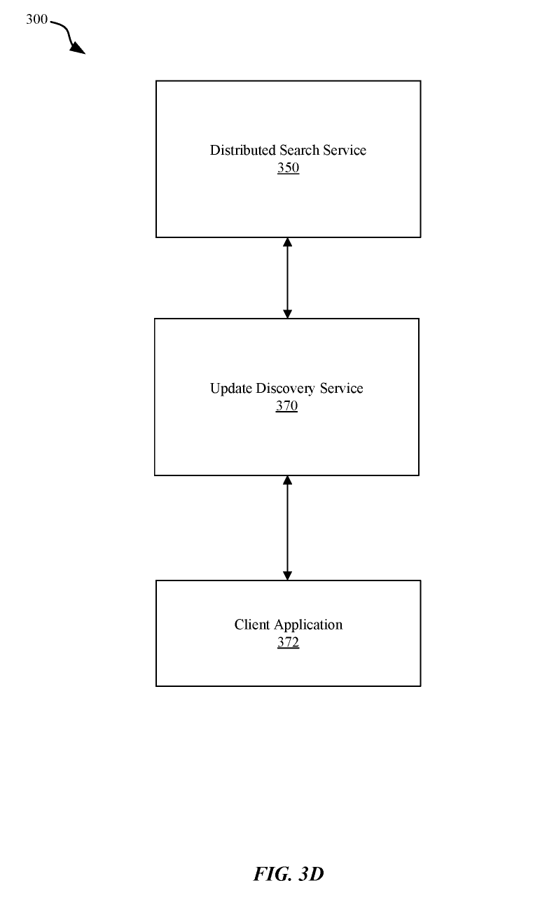

FIGS. 3A-3D illustrate conceptual diagrams of various services, executing on a server computing device, that implement various aspects of a digital distribution platform 300, in accordance with some embodiments. In particular, and as illustrated throughout FIGS. 3A-3D, the various services can include a content submission service 310, an indexing service 330, a distributed search service 350, and a software update service 370. It is noted that each service can include one or more instances of the service executing on one or more server computing devices without departing from the scope of this disclosure.

As shown in FIG. 3A, the content submission service 310 enables a package of resources for an application to be submitted to the digital distribution platform 300. In some embodiments, the digital distribution platform 300 can include one or more CDNs 110 as described in FIG. 1. Multiple copies of the package of resources for a particular version of the application can be stored on two or more CDNs 110, where each CDN 110 represents a different availability zone associated with different geographic regions. In various embodiments, multiple CDNs 110 can be implemented to serve a single region and/or availability zone.

In some embodiments, the content submission service 310 aggregates multiple resources within a package of resources submitted to the digital distribution platform 300 into a single aggregate data structure for storage in a CDN 110. According to some embodiments, the aggregate data structure can be represented by a single file. In various embodiments, the aggregate data structure can be compressed by the content submission service 310 to reduce a size of the package of resources as stored on the CDNs 110. Compressing the package of resources within the aggregate data structure reduces network bandwidth required to transmit the package of resources from the digital distribution platform 300 to client devices. The package of resources is then decompressed by the client device prior to installation on the client device.

In some embodiments, a software developer can utilize a client application 312 executing on a computing device that is in communication with the server computing device executing the content submission service 310. The client application 312, in conjunction with the content submission service 310, enables the software developer to submit a package of resources for a particular version of an application to be managed by the one or more CDNs 110. The client application 312 can be a web-based application accessed through a browser running in an operating environment of the computing device. Alternatively, the client application 312 can be a stand-alone application developed for a target platform of the computing device and executed within an operating system environment of the computing device. As previously noted herein, the package of resources can include one or more binary executables that, when installed on a client device and executed by a processor of the client device, cause the client device to run the application within an operating environment of the client device.

In some embodiments, the client application 312 enables the software developer to specify various parameters related to a rollout of an update to an application to client devices that (1) are connected to the digital distribution platform 300, and (2) currently have the application installed thereon—referred to herein as “target client devices.” As used herein, the term “rollout” can refer to a period of time during which the package of resources for an update to a previous version of the application is made available to the target client devices. For example, the client application 312 can enable a software developer to specify a release date to begin the rollout of the update to target client devices. It is noted that the term “release date” can refer to a particular day on a calendar, a time identified by seconds, minutes, hours, and/or days from a reference time, and so on. Additionally, the client application 312 can enable a software developer to specify whether the rollout should be immediate, or gradual over a period of time. In particular, an immediate rollout refers to authorizing all client devices connected to the digital distribution platform 300 to install the update after the release date. In contrast, a gradual rollout refers to authorizing only a subset of client devices connected to the digital distribution platform 300 to immediately install the update after the release date, followed by additional subsets of the client devices as the period of time progresses.

In some embodiments, the number of authorized client devices in the subset of client devices can be dynamically adjusted during the period of time according to a pre-defined function. In particular, the pre-defined function can define what is referred to herein as an authorization curve. According to some embodiments, the authorization curve defines a threshold value that is dependent on one or more variables (e.g., elapsed time), and utilized to determine whether a client device is authorized to install an update to the application. In some embodiments, the number of authorized client devices in the subset of client devices can be dynamically adjusted during the period of time according to a custom function submitted by a software developer utilizing the client application 312. Thus, the software developer can define the overall behavior of the gradual rollout in accordance with the authorization curve defined by the custom function. Alternatively, the number of authorized client devices in the subset of client devices can be dynamically adjusted based on a selected function from a set of pre-defined functions. For example, the set of pre-defined functions can enable the software developer to choose between more aggressive or less aggressive authorization curves defined by the pre-defined functions. It is noted that while the set of pre-defined functions are not customizable by the software developer, they beneficially enable the software developer to coarsely adjust the aggressiveness of the gradual rollout.

In some embodiments, the content submission service 310 manages the utilization of storage resources 130 within a plurality of CDNs 110 included in the digital distribution platform 300. In various embodiments, the content submission service 310 performs load balancing operations that determine where to store a package of resources for a particular version of an application submitted to the digital distribution platform 300.

Turning now to FIG. 3B, the indexing service 330 enables a record to be created for each version of the application submitted to the digital distribution platform 300 via the content submission service 310. In some embodiments, the record can include a uniform resource locator (URL) that identifies, for example, a location of the package of resources corresponding to a particular version of the application within the digital distribution platform 300, a description associated with the particular version of the application, an application identifier, a version identifier of the particular version of the application, and so on. It will be appreciated that a particular application can be associated with a number of different records, where each record corresponds to a different version of the application submitted to the digital distribution platform 300.

In some embodiments, each record generated by the indexing service 330 can include a list of resources included in the package of resources. If the record is associated with an update for a previous version of an application installed on client devices, then the record can also include information that specifies the previous version of the application associated with the update (e.g., the record can include a version identifier for the previous version of the application).

In some embodiments, the indexing service 330 stores the records in a database 332. The database 332 enables queries to be used to find specific resources stored on the CDNs 110 of the digital distribution platform 300. In various embodiments, the database 332 can be a distributed database stored on multiple server computing devices at various geographic locations communicating via a network.

As shown in FIG. 3C, the distributed search service 350 enables the database 332 to be queried. The functionality of the distributed search service 350 provides a front end for the database 332. The records created by the indexing service 330 and stored in the database 332 enable the distributed search service 350 to create queries structured for the database 332 that return lists of records that match the queries. For example, the database 332 can be queried to return a list of all applications with one or more versions available on the digital distribution platform 300. Alternatively, the database 332 can be queried to return a list of all available versions of a particular application that are available on the digital distribution platform 300. In turn, a location of a package of resources for a particular version of an application can be identified using a specific query that causes the database 332 to return a record for that package of resources.

As shown in FIG. 3D, the update discovery service 370 enables a client application 372, executing on a client device, to search for updates to applications installed on the client device. In some embodiments, the client application 372 can transmit a request to the update discovery service 370 to identify whether updates are available for one or more applications installed on the client device. The update discovery service 370 receives the request from the client application 372 and generates a corresponding request that is transmitted to the distributed search service 350 to search for any updates for a particular application identified in the request received from the client application 372. In turn, the distributed search service 350 queries the database 332 to determine if any updates are available for the particular application. The database 332 returns a list of records associated with the application in response to the query. The list of records identifies different versions of the application that are available on the digital distribution platform 300. The distributed search service 350 can then parse the list of records to identify a version identifier included in one of the records for a current version of the application to the update discovery service 370. It is noted that the current version of the application can refer to a particular version identifier having the greatest value, a particular version identifier associated with the most recently uploaded version of the application, a particular version identifier marked as the current version of the application, and so on. In any case, the update discovery service 370 compares an installed version identifier corresponding to the version of the application installed on the client device—which can be provided by the client application 372 in the request—with the version identifier for the current version of the application identified by the distributed search service 350. In this manner, the update discovery service 370 can effectively determine whether an update to the application installed on the client device is available on the digital distribution platform 300. If an update is available on the digital distribution platform 300, then the update discovery service 370 transmits a response to the client application 372 that indicates that the update is available to be installed on the client device.

In some embodiments, the client application 372 (executing on the client device) can maintain a list of applications that are installed on the client device, where each different application is represented by a unique application identifier. In some embodiments, the application identifier is assigned to an application by the indexing service 330 when a software developer uploads a package of resources for an initial version of the application to the digital distribution platform 300. The indexing service 330 creates a unique version identifier for each new version of the application uploaded to the digital distribution platform 300, including both major versions of the application and updates to previous versions of the application. It is noted that all records associated with any version of the application can include the same application identifier, whereas each record for a different version of the application can include a unique version identifier.

In additional embodiments, the update discovery service 370 can utilize a user account service to identify a list of applications installed on a particular client device associated with a user account. In turn, the client application 372 is not required to provide a list of application identifiers to the update discovery service 370 in the request. Instead, the request merely provides information in the request to identify the client device, and the update discovery service 370 passes the information to the user account service to return a list of applications that are installed on the client device. The update discovery service 370 can then identify whether any updates are available for applications installed on the client device.

In additional embodiments, the client application 372 does not transmit a request to the update discovery service 370. Instead, the update discovery service 370 is periodically called by the user account service to determine if any updates are available for applications installed on the client device. In this regard, the update discovery service 370 can be configured to push a notification to the client application 372 when an update is available for any applications installed on the client device.

It will be appreciated that the services described above in conjunction with FIGS. 3A-3D can be implemented on a single server computing device. For example, the content submission service 310, the indexing service 330, the distributed search service 350, and the update discovery service 370 can be implemented on the same server computing device. Alternatively, the content submission service 310, the indexing service 330, the distributed search service 350, and the software update service 370 can be implemented across different server computing devices connected to a network. In other embodiments, one or more of the content submission service 310, the indexing service 330, the distributed search service 350, and the software update service 370 can be implemented in the gateway server 115 of a CDN 110, or implemented on a separate server computing device located behind the gateway server 115 in the CDN 110.

As previously noted herein, a rollout of an update to an application can be controlled through the digital distribution platform 300. The content submission service 310 can enable selection of a gradual rollout option when the update to the application is submitted to the digital distribution platform 300. The gradual rollout option causes the update discovery service 370 to limit the number of client devices that are authorized to install an update to the application during the rollout. When the gradual rollout option is selected, the update discovery service 370 is configured to determine whether a given client device (on which the application is installed) is authorized to install the update to the application. The record created by the indexing service 330 for an update can indicate that a gradual rollout option was selected to control the rollout of the update to the application. It will be appreciated that there is no additional overhead required to control the rollout of an update gradually rather than immediately. In other words, the update discovery service 370 includes all of the logic and data to implement a gradual rollout rather than an immediate rollout of an update for an application.

In some embodiments, determining whether the client device is authorized to install the update is performed by sorting the client device into a first subset of client devices or a second subset of client devices. In particular, the first subset of client devices are authorized to install the update to the application, and the second subset of client devices are not authorized to install the update to the application. The goal of the gradual rollout option is to delay the adoption of the update by client devices such that a software developer can react to the discovery of bugs in the update without the bugs degrading the user experience for a large portion of the application's user base. For example, a particular software application could be installed on one million devices, but the gradual rollout option can limit the update to being installed on ten thousand devices for a fixed time period at the beginning of the rollout, thereby limiting the effect of any bugs in the update to those ten thousand devices rather than exposing all one million devices to those bugs. This delay can enable the software developer to pause/cancel the rollout and create a new version of the application that fixes the discovered bugs so that the entire user base is not exposed to those bugs.

In some embodiments, the content submission service 310 enables a rollout of an update to an application to be paused. The gradual rollout option dynamically increases the number of client devices authorized to install the update over a period of time. The content submission service 310 enables a software developer to pause the rollout during the period of time such that the number of client devices authorized to install the update is fixed while the rollout is paused. Alternatively, no client devices are authorized to install the update while the rollout is paused; however, the number of client devices authorized to install the update resumes dynamically increasing from the number of client devices that were authorized to install the update immediately prior to the rollout being paused. In some embodiments, the content submission service 310 enables a rollout of an update to an application to be canceled. Cancelling the rollout results in no client devices being authorized to install the update. In various embodiments, a canceled rollout can be resumed, and the rollout will proceed as if the update is being rolled out to client devices for the first time. In some embodiments, the content submission service 310 enables a rollout of an update to an application to be advanced. For example, during a rollout of an update to an application where a software developer selected the gradual rollout option during submission of the update, the update can be made available to all client devices (e.g., all client devices are authorized to install the update) regardless of the previous rollout schedule.

It will be appreciated that a software developer may begin a rollout for an update using the gradual rollout option. However, at some point during the rollout, the software developer may determine that the update is stable and advance the rollout to all client devices. Some updates to an application may be urgent security updates to fix a discovered vulnerability. In such cases, these updates can be rolled out to client devices without selecting the gradual rollout option so that all client devices have access to the urgent security update immediately. In other words, different updates associated with the same application can be rolled out to client devices in different manners depending on the desire of the software developer when submitting the updates using the content submission service 310.

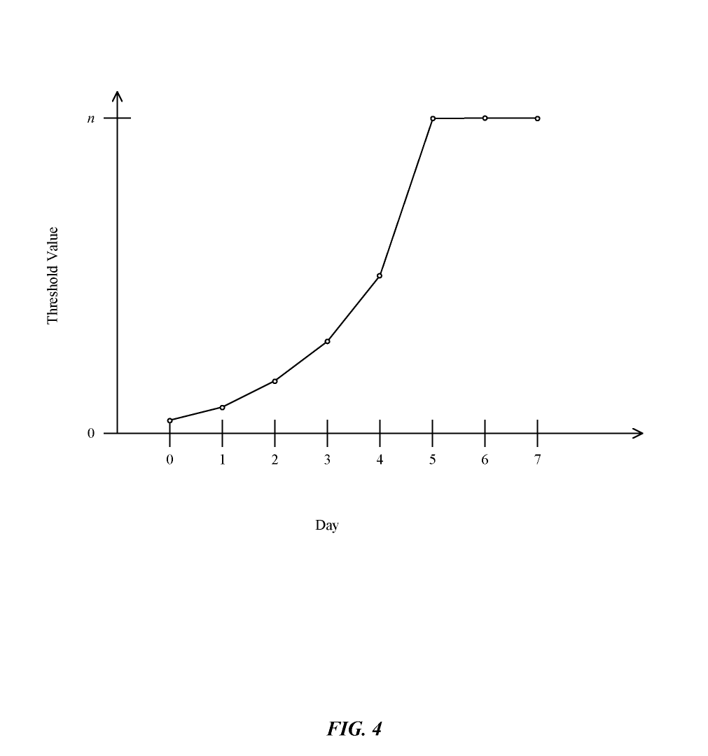

FIG. 4 illustrates an exemplary function for selecting a threshold value associated with a controlled rollout of an update for an application, in accordance with some embodiments. As shown in FIG. 4, the function can be based on an elapsed time that reflects a difference between a current date and a release date for the update. As a brief aside, it is noted that the term “date” used herein incorporates both date and time components to provide a finer level of precision with respect to the manner in which application updates are rolled out. In any case, the current date can mark a point in time where a service is determining whether a particular client device is authorized to install the update to the application. Additionally, the release date marks the beginning of the rollout (e.g., the point in time that at least one client device could install the update from the digital distribution platform). Again, the release date and current date can be specified in any unit of time, such as—but not limited to—a number of months, weeks, days, hours, minutes, or seconds, or any combination thereof. The function for selecting the threshold value enables the threshold value to be adjusted dynamically based on the elapsed time. Consequently, in some embodiments, the function for selecting the threshold value can return an exponentially increasing threshold value based on the elapsed time.

As shown in FIG. 4, the function for selecting the threshold value can be an exponentially increasing function. For example, during the first day of the rollout (illustrated in FIG. 4 as day zero (0)), the threshold value can be low, e.g., a value of one; during the second day, the threshold value can be increased, e.g., to a value of two; during the third day, the threshold value can be further increased, e.g., to a value of five; during the fourth day, the threshold value can be further increased, e.g., to a value of ten; during the fifth day, the threshold value can be further increased, e.g., to a value of thirty; and so forth, until the threshold value reaches a value n that represents a maximum threshold value within a range (0, n]. In some embodiments, the value n is set equal to one-hundred (100) such that each value of the threshold value returned by the function represents a percentage of client devices authorized to install the update during a given day of the rollout.

In some embodiments, the threshold value returned by the function can be utilized in a sorting algorithm that divides a set of client devices into at least two subsets of client devices. In particular, a first subset of client devices represents the client devices that are authorized to install the update to the application, while a second subset of client devices represents the client devices that are not authorized to install the update to the application. The sorting algorithm can assign each client device in the plurality of client devices a value within the range that bounds all possible threshold values. In various embodiments, the distribution of client devices assigned particular values may be approximately uniform (e.g., the number of client devices assigned each number should be relatively equal within a particular error bound). The sorting algorithm can then divide the client devices into the first subset or the second subset by comparing the value assigned to the client device with the threshold value according to any criteria. For example, the first subset can include all client devices assigned a value less than the threshold value. It is noted that other criteria can be utilized by the sorting algorithm in lieu of the criteria provided in the foregoing example. For instance, the criteria can involve identifying values that are less than or equal to the threshold value, greater than the threshold value, greater than or equal to the threshold value, and so on.

In some embodiments, each client device is assigned a value to compare against the threshold value using a hash function. An output of the hash function is referred to as a hash value and can be restricted to a range that overlaps the range of threshold values. For example, the hash values returned by the hash function can be limited to the range [0, k), where k=n. It will be appreciated that the range of hash values and the range of threshold values can be selected based on the chosen criteria being utilized for the comparison. For example, if a “greater than” comparison is being used, then the range of threshold values can be selected as [0, n), and the range of hash values can be selected as (0, k].

An example hash function is provided below as Equation 1:

h(x)=x mod(k), (Eq. 1)

where x is the input value and the result of the hash function h(x) is the hash value. As an example, when k is equal to 100, the hash function h(x) applies a modulo operation to the input value x, wherein the modulus is 100. In other words, the hash value resulting from the hash function h(x) in Equation 1 is the remainder of the Euclidean division of the input value by the modulus of k. In various embodiments, the hash function can be chosen to uniformly distribute the hash values in the range of hash values, given a known set of input values.

In some embodiments, an input to the hash function is based on: (1) a user identifier corresponding to a user account associated with the client device; and (2) a version identifier corresponding to the update. The input to the hash function can be generated by calculating a sum of the user identifier and the version identifier. Alternatively, the input to the hash function can be generated by applying some other operation to the user identifier and/or the version identifier. In some embodiments, the user identifier and the version identifier are stored as integer values. For example, each of the user identifier and the version identifier can be stored as a 32-bit unsigned integer having a range of 0 to 4,294,967,295. Alternatively, the user identifier and version identifier can be stored using other formats such as 16-bit signed or unsigned integers, 64-bit signed or unsigned integers, floating-point values, character strings, and the like. In various embodiments, the user identifier and/or version identifier can be converted from one format to another format prior to calculating the sum. For example, a version identifier could be stored as a character string that may be parsed and converted into a useful format for an addition operation such as an integer format.

It will be appreciated that the determination of whether a client device is authorized to install an update depends on the hash value, which changes based on the user identifier and the version identifier used to calculate the input to the hash function. A particular user identifier can be associated with multiple client devices corresponding to a unique user account. For example, a particular user account may be associated with a laptop computer, a tablet computer, one or more mobile phones, a wearable device, and the like. The hash function enables all client devices associated with a particular user account to maintain a similar user experience by authorizing or not authorizing all client devices associated with a particular user account to install an update to a particular version of an application. If the hash function was based on a client device identifier instead of the user identifier, then the result could be that a first client device associated with a user account is authorized to install the update, while a second client device associated with the same user account is not authorized to install the update. This can lead to a user experience divergence for the application between the first and second client devices associated with the same user account.

It will also be appreciated that the sum of the version identifier and the user identifier prevents a particular client device from always being associated with the same hash value. In other words, for a given user identifier, the hash value generated by the hash function will change based on the version identifiers for different updates for an application. Therefore, even if the client device is authorized to install a first update for an application early in a rollout of the first update, the client device may not be authorized to install a second update for the application until later in the rollout for the second update because the hash value changes based on the version identifiers corresponding to the first update and the second update. Consequently, including the version identifier when calculating the sum for the input value of the hash function can prevent client devices associated with a given user account from always being authorized to install updates early in a rollout based on a fixed user identifier.

In various embodiments, the hash function is based on the user identifier corresponding to a user account associated with the client device, an application identifier corresponding to the application, and a version identifier corresponding to the update to the application. The application identifier can be added to cause a variety of hash values to be produced between different applications sharing the same version identifier installed on client devices associated with a particular user account. For example, even though a version identifier for a first application and a second application are the same (e.g., 23), the application identifier for the first application and the application identifier for the second application cause different hash values to be generated by the same hash function. Consequently, including the application identifier when calculating the sum for the input value of the hash function can prevent client devices associated with a given user account from always being authorized to install updates for different applications early in a rollout based on a common version identifier.

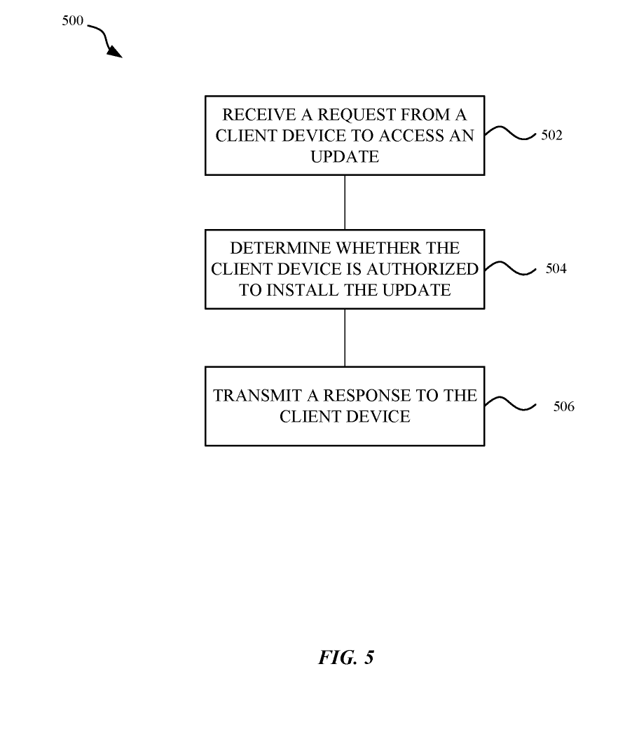

FIG. 5 illustrates a flowchart of an exemplary method 500 to control a rollout for an update to an application installed on client devices, in accordance with some embodiments. The method 500 can be performed by hardware, software executed by a processor, or any combination of hardware and software.

At step 502, a request from a client device is received, at a server, to identify whether an update for an application is available via a digital distribution platform. The request can be received from a client application, executing on the client device, which is configured to manage applications installed on the client device and update the applications when new versions of the applications are available via a digital distribution platform.

At step 504, the server determines whether the client device is authorized to install the update. In some embodiments, the server is configured to sort the client device into a first subset of client devices or a second subset of client devices. The sorting is performed based on, at least in part, a user identifier and a version identifier. The user identifier corresponds to a user account associated with the client device, and the version identifier corresponds to the update for the application.

At step 506, the server transmits a response to the client device. In some embodiments, the response includes the version identifier corresponding to the update when the client device is authorized to install the update. Alternatively, if the client device is not authorized to install the update, the response includes a second version identifier corresponding to a previous version of the application. In various embodiments, the response can omit the version identifier and include a URL associated with a particular version of the application that can be installed on the client device, or the response includes a package of resources for a particular version of the application that can be installed on the client device. In some embodiments, the response is transmitted to the client device only when the client device is authorized to install the update; otherwise, the server refrains from transmitting a response to the client device. The client device can implement a timeout period that, once expired without receiving a response from the server, indicates that the client device is not authorized to install the update.

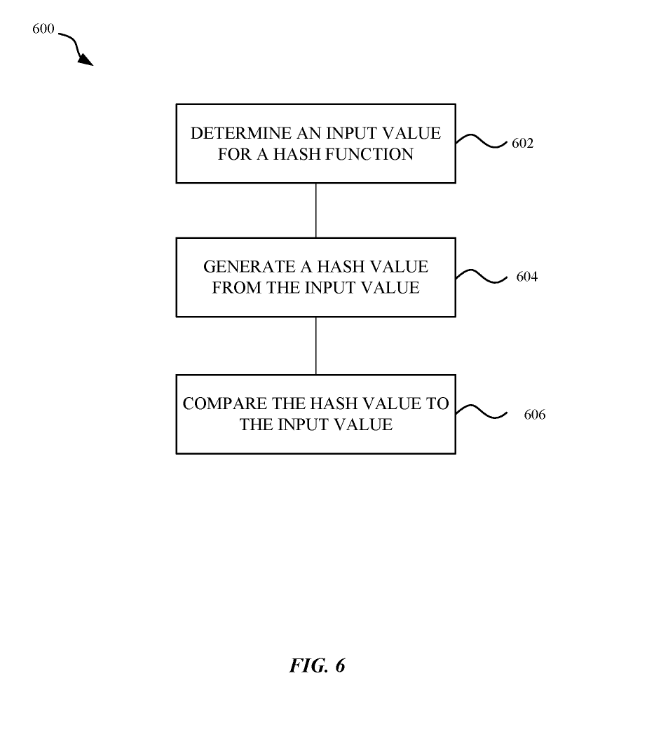

FIG. 6 illustrates a flowchart of an exemplary method 600 for determining whether a client device is authorized to access an update to an application, in accordance with some embodiments. The method 600 can be performed by hardware, software executed by a processor, or any combination of hardware and software. In some embodiments, the method 600 can be implemented within step 504 of the method 500 illustrated in FIG. 5.

At step 602, a server determines an input value for a hash function. In some embodiments, the input value is calculated by summing a user identifier and a version identifier. The user identifier and the version identifier can be converted, if necessary, to a common format compatible with an addition operation performed within the server. In various embodiments, the input value is calculated by summing a user identifier, an application identifier, and a version identifier.

At step 604, the server generates a hash value based on the input value. In some embodiments, the hash function applies a modulo operation to the input value to generate the hash value. For example, the hash function can use a modulus of 100 to return hash values, based on applying a modulo operation using modulus 100 to any unsigned integer input value, between 0 and 99. In various embodiments, the hash value can be restricted to a range of [0, n) or (0, n]. For example, the hash function can return integers in the range of [0, 100), the range of [0, 1000), or any other range of values that can be compared to a threshold value.

At step 606, the server compares the hash value to a threshold value to sort the client device into either the first subset of devices authorized to install the update or the second subset of device not authorized to install the update. The threshold value is selected by a function based on one or more variables. In some embodiments, the threshold value is selected by a function based on an elapsed time calculated by subtracting a release date associated with the update from a current date.

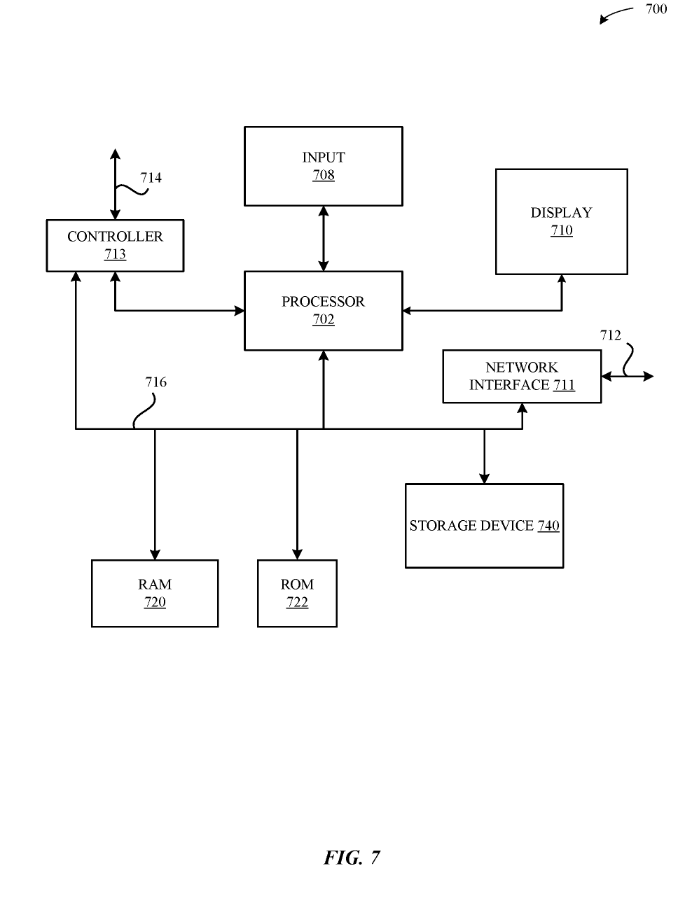

FIG. 7 illustrates a detailed view of an exemplary computing device 700 that can be used to implement the various apparatus and/or methods described herein, in accordance with some embodiments. In particular, the detailed view illustrates various components that can be included in the computing devices illustrated in FIGS. 1 to 3D and/or described herein. For example, one or more of the client device(s) 190, gateway server(s) 115, storage server(s) 125, or any other device including any network device, computing device, and/or server computing device included in digital distribution platforms 100 or 300 can include the components of computing device 700.

As shown in FIG. 7, the computing device 700 can include a processor 702 that represents a microprocessor or controller for controlling the overall operation of computing device 700. The computing device 700 can also include a user input device 708 that allows a user of the computing device 700 to interact with the computing device 700. For example, the user input device 708 can take a variety of forms, such as a button, keypad, dial, touch screen, audio input interface, visual/image capture input interface, input in the form of sensor data, etc. Still further, the computing device 700 can include a display 710 (screen display) that can be controlled by the processor 702 to present visual information to the user. A data bus 716 can facilitate data transfer between at least a storage device 740, the processor 702, and a controller 713. The controller 713 can be used to interface with and control different equipment through an equipment control bus 714. The computing device 700 can also include a network/bus interface 711 that couples to a data link 712. In the case of a wireless connection, the network/bus interface 711 can include a wireless transceiver.

In some embodiments, the processor 702 can be embodied in a variety of forms. For example, the processor 702 can be embodied as various processing hardware-based means such as a microprocessor, a coprocessor, a controller or various other computing or processing devices including integrated circuits such as, for example, an application specific integrated circuit (ASIC), a field programmable gate array (FPGA), some combination thereof, or the like. Although illustrated as a single processor, it will be appreciated that the processor 702 can include two or more processors. The processors can be in operative communication with each other and can be collectively configured to perform one or more functionalities of the computing device 700 as described herein. In some embodiments, the processor 702 can be configured to execute instructions that can be stored in the RAM 720 or that can be otherwise accessible to the processor 702.

The computing device 700 also include a storage device 740, which can comprise a single disk or a plurality of disks (e.g., hard drives), and includes a storage management module that manages one or more partitions within the storage device 740. In some embodiments, storage device 740 can include flash memory, semiconductor (solid state) memory or the like. The computing device 700 can also include a Random-Access Memory (RAM) 720 and a Read-Only Memory (ROM) 722. The ROM 722 can store programs, utilities or processes to be executed in a non-volatile manner. The RAM 720 can provide volatile data storage, and stores instructions related to the operation of the computing device 700.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for controlling a rollout of an update for an application installed on client devices, the method comprising, by at least one server:
receiving a request to identify whether the update is available via a digital distribution platform;
determining whether a client device is authorized to install the update by:
sorting the client device into a first subset of client devices or a second subset of client devices based on, at least in part:
a user identifier corresponding to a user account associated with the client device, and
a version identifier corresponding to the update,
wherein:
the client device is authorized to install the update when the client device is sorted into the first subset of client devices, and
the client device is not authorized to install the update when the client device is sorted into the second subset of client devices.

2. The method of claim 1, wherein sorting the client device into the first subset of client devices or the second subset of client devices comprises:
calculating a sum of the user identifier and the version identifier to generate an input value for a hash function; and
generating, via the hash function, a hash value based on the input value.

3. The method of claim 2, wherein the hash function applies a modulo operation to the input value to generate the hash value.

4. The method of claim 2, wherein sorting the client device into a first subset of client devices or a second subset of client devices further comprises:
comparing the hash value to a threshold value to sort the client device into the first subset of client devices or the second subset of client devices.

5. The method of claim 4, wherein the threshold value is selected by a function based on an elapsed time calculated by subtracting a release date associated with the update from a current date.

6. The method of claim 5, wherein the function is pre-defined to return an exponentially increasing threshold value based on the elapsed time.

7. The method of claim 5, wherein the function is selected from a set of pre-defined functions including at least two pre-defined functions.

8. The method of claim 2, wherein the sum further includes an application identifier corresponding to a plurality of versions of the application.

9. The method of claim 1, wherein the digital distribution platform comprises one or more content delivery networks (CDNs), each CDN in the one or more CDNs including:
a gateway server; and
one or more storage servers coupled to storage resources for storing a plurality of packages of resources for different versions of the application.

10. The method of claim 1, wherein the digital distribution platform includes at least one server computing device configured to implement:
a content submission service that enables a software developer to submit one or more packages of resources corresponding to different versions of the application to be stored on the one or more CDNs;
an indexing service that enables a record to be created for each version of the application submitted via the content submission service;
a distributed search service that enables a database of records created by the indexing service to be queried; and
an update discovery service that receives the request and determines whether the client device is authorized to install the update.

11. The method of claim 1, wherein the request includes the user identifier corresponding to the user account associated with the client device.

12. The method of claim 1, further comprising transmitting a response to the request that includes:
the version identifier when the client device is authorized to install the update, or
a second version identifier corresponding to a previous version for the application when the client device is not authorized to install the update.

13. A server computing device for controlling a rollout of an update for an application installed on client devices over a network, the server computing device comprising:
at least one processor; and
at least one memory storing instructions that, when executed by the at least one processor, cause the server computing device to implement a service configured to:
receive a request from a client device to access the update,
determine whether the client device is authorized to access the update during a rollout period for the update based on, at least in part:
a user identifier corresponding to a user account associated with the client device, and
a version identifier corresponding to the update, and
transmit a response to the client device when the client device is authorized to access the update.

14. The server computing device of claim 13, wherein the client device is authorized to access the update when a hash value generated by a hash function is less than a threshold value associated with a number of elapsed days in the rollout period.

15. The server computing device of claim 14, wherein the hash function is further based on an application identifier.

16. The server computing device of claim 13, wherein the server computing device is included in a digital distribution platform that comprises a digital store for purchasing applications to be installed on client devices.

17. At least one non-transitory computer readable storage medium configured to store instructions that, when executed by at least one processor included in a server computing device, cause the server computing device to control a rollout of an update for an application installed on a client device, by carrying out steps that include:
receiving a request to identify whether the update is available to be installed on the client device during the rollout;
calculating a hash value based on, at least in part:
a user identifier corresponding to a user account associated with the client device, and
a version identifier corresponding to the update;
determining whether the update for the application is available to be installed on the client device by comparing the hash value to a threshold value based on a number of days that have elapsed since the update was released; and
in response to determining that the update for the application is available to be installed on the client device, transmitting a response to the client device.

18. The at least one non-transitory computer readable medium of claim 17, wherein the hash value is based on a sum of the user identifier, the version identifier, and an application identifier associated with a plurality of different versions of the application

19. The at least one non-transitory computer readable medium of claim 18, wherein at least one of the user identifier, the version identifier, or the application identifier is converted from a first format to a second format prior to calculating the sum.

20. The at least one non-transitory computer readable medium of claim 17, wherein the request includes the user identifier.
